(19) United States
(12) Patent Application Publication
(10) Pub. No.: US 2006/0126206 A1
(43) Pub. Date: Jun. 15, 2006

(54) Method of writing servo data and magnetic disk drive

(75) Inventors: Yuhji Takagi, Kanagawa (JP); Hiroshi Uchiike, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/285,911

(22) Filed: Nov. 23, 2005

(30) Foreign Application Priority Data
Dec. 15, 2004 (JP) 2004-362851

(51) Int. Cl. G11B 5/09; G11B 21/02

(52) U.S. Cl. 360/46; 360/48; 360/75

(57) ABSTRACT

Servo data is stably written even if the flying height of a head/slider is varied. In one embodiment, a seamed pattern of servo data is written by a write head that is equipped in a head/slider. A variation pattern signal of the flying height in the circumferential direction of a magnetic disk is generated. The write head is located at a given position of the magnetic disk. The seamed pattern is written while controlling a recording current to flow in the write head on the basis of the variation pattern. At a constant recording current, a pattern length L1 is shortened when a flying height H1 is higher, and a pattern length L2 is lengthened when a flying height H2 is lower. The magnitude of the recording current is controlled according to the variation of the flying height, thereby making it possible to fall a pattern length L within a constant range, and accurately define the position of an edge of the seamed pattern.

### CROSS-REFERENCES TO RELATED APPLICATIONS

This application claims priority from Japanese Patent Application No. JP2004-362851, filed Dec. 15, 2004, the entire disclosure of which is incorporated herein by reference.

### BACKGROUND OF THE INVENTION

The present invention relates to a technique for writing accurate servo data in a magnetic disk without suffering from an influence of variations of flying height which occur in a head/slider equipped in a magnetic disk drive. The invention relates more particularly to a technique for writing user data having stable pattern length in the magnetic disk even if the flying height varies.

A magnetic disk drive operates as follows. A slider on which a magnetic head is formed (hereinafter, the combination of the magnetic head and the slider are called “head/slider”) receives a lifting force that is attributable to an airflow developed on a magnetic disk surface that rotates at a constant revolution speed. The lifting force generated allows the slider to levitate from the magnetic disk surface with a slight height (hereinafter, a gap between the magnetic head and the magnetic disk surface is called “flying height”) to record or reproduce data. The magnetic disk is fixed to a hub of a spindle motor with a clamp mechanism. A dish-shaped thin plate spring which is a primary part of the clamp mechanism elastically fixes the magnetic disk to the hub. However, a slight unbalance of a pushing force, which is attributable to a manufacturing tolerance of the thin plate spring, may distort the magnetic disk. Also, the magnetic disk per se has a slight natural distortion.

When the magnetic disk that is slightly distorted with respect to a certain plane is rotated, a gap between a position that is slightly apart from the magnetic disk surface and the magnetic disk surface is cyclically varied. The cyclic variation of the gap causes a cyclic variation of the flying height when the head/slider is positioned at a specific track. The magnetic disk drive acquires information for controlling the position of the head from servo data which is written in the magnetic disk. The write system of servo data includes a system in which data is written by a single magnetic disk, and a system in which data is written by means of a write head that is mounted in the magnetic disk drive after the magnetic disk is incorporated into a base.

Before servo data is written in the magnetic disk, no data for positioning the head is recorded on the magnetic disk. In the system where servo data is written by means of the write head mounted in the magnetic disk drive, various methods of controlling the position of the write head to write the servo data are employed. In a first method, the write head is positioned by a specific device such as a servo track writer. Servo track writers include a contact type head position control method and a noncontact type head position control method. In the contact type head position control method, a push pin is pushed against a carriage assembly that positions the write head to a given track to mechanically control the position. In the noncontact type head position control method, positional information is given by irradiating the carriage with a laser beam by means of a VCM control system of the magnetic disk drive. Writing techniques of servo data using the servo track writer are disclosed in, for example, Patent Document 1 (Japanese Patent Laid-open No. 8-255448) or Non-patent Document 1 (Structure and application of a hard disk drive, issued by CQ publishing company on Jul. 1, 2003). When the positioning system using the servo track writer is employed, it is necessary to at least partially open the interior of the magnetic disk drive. Accordingly, this type of positioning system must be performed within a clean room.

As a second method, there is a system in which after all structural elements of the magnetic disk drive such as a magnetic disk or a carriage assembly are mounted in the base and sealed with a cover, the mounted magnetic head is positioned by means of provisional servo data that is recorded in a user sector, and servo data for products is recorded in the servo sector. A method of writing the provisional servo data involves a system in which first servo data as a reference is written by an external device in advance as disclosed in Patent Document 1. Further, there is a method in which all of provisional servo data is written by the mounted magnetic head as disclosed in Patent Document 2 (Japanese Patent Laid-open No. 2003-141835). The system of thus recording the servo data for products by means of the provisional servo data is generally called “self servo write system”.

In the present specification, servo data to be used as products is recorded in the servo sector by means of the write head mounted in the magnetic disk drive regardless of the positioning system used in the magnetic head as exemplified in the first or second method. Such a positioning system is called “self head servo write system”. When servo data is written by the self head servo write system, the above problem caused by the variation in the flying height may arise depending on some type of burst pattern used for track following within the servo data. Also, Patent Document 3 (Japanese Patent Laid-open No. 7-57376) discloses a technique in which it is detected that abnormality has occurred in the flying height of the head due to a gain of AGC.

### BRIEF SUMMARY OF THE INVENTION

An induction write head is generally employed as the write head of the magnetic disk drive. As shown in FIG. 1, the induction write head has an upper magnetic pole 1 and a lower magnetic pole 2 opened at a position that faces the magnetic disk to form a write gap. A magnetic flux induced within the magnetic pole due to a current that flows in a coil 3 goes to a space from an end of the upper magnetic pole 1 and returns to an end of the lower magnetic pole 2 at the write gap. In this situation, the magnetic flux 5 passes through a magnetic layer 9 formed on a surface of a substrate 13 of the magnetic disk and magnetizes the magnetic layer 9 to record information. A magnetic flux that goes from the end of the upper magnetic pole 1 and returns to the end of the lower magnetic pole 2 spreads in a radial direction of the disk as shown in FIG. 1. In fact, the magnetic flux 5 flows with various magnetic flux densities according to spatial positions so that the magnetic flux densities become lower toward the outer side. However, in FIG. 1, an outer position defined by the magnetic flux densities sufficient to magnetize the magnetic layer is representatively expressed by one line.

FIG. 1(A) shows a state in which the head/slider is levitated by a representative flying height H. FIG. 1(B) shows a state in which a flying height H1 becomes higher than the flying height H. FIG. 1(C) shows a state in which a flying height H2 becomes lower than the flying height H. Referring to FIG. 1(A), a distance L between positions where the magnetic layer 9 and the magnetic flux 5 cross each other is a value indicative of a radical pattern length L of information which is recorded in the magnetic layer by magnetizing the magnetic layer. The pattern length L corresponds to a length by which the magnetic layer is magnetized in the substantial radial direction of the magnetic disk. When the flying height H is constant, the spread of the magnetic flux 5 becomes larger as a current that flows in the coil 3 is larger, and the pattern length L is also longer. Also, when the current that flows in the coil 3 is constant, the pattern length L1 (L1<L) becomes shorter as the flying height H1 (H1>H) is higher as shown in FIG. 1(B). In addition, the pattern length L2 (L2>L) becomes longer as the flying height H2 (H2<H) is shorter as shown in FIG. 1(C).

A significance resides in that when a width W of the upper magnetic pole 1 that forms a write gap is constant, the pattern length L that is recorded in the magnetic layer changes with the magnitude of a recording current that flows in the coil 3 and an influence of the flying height. The flying height may accidentally vary with an influence of airflow when the head/slider is in seek operation or shocks from the external are applied. However, the present invention deals with the variation of flying height which cyclically occurs between the rotating magnetic disk and the head/slider that levitates above the magnetic disk. Such variation of flying height is caused by a deviated fastening force of the clamp mechanism with respect to the magnetic disk, or the degradation of the flatness which occurs in the magnetic disk, which is attributable to the manufacturing tolerance of the magnetic disk.

FIG. 2 is a diagram for explaining a state in which when data is recorded while the write head travels on one line with the center of a track by allowing a constant recording current to flow in the write head, the flying height of the head/slider varies, and the pattern length of the magnetized magnetic layer varies. FIG. 2 shows a state in which the pattern length L of the data pattern that has been written on one round of the track varies when the constant recording current is made to flow in the write head while the induction write head follows a given track position with respect to the magnetic disk whose flatness is deteriorated. Although user data is not recorded in the servo sector, the servo sector is ignored in FIG. 2. FIG. 2(A) shows that the flying height goes up and the pattern length L becomes shorter at points A and C on the circumference of the track, and the flying height goes down and the pattern length L becomes longer at points B and D.

Also, in FIG. 2(B), the flying height goes up and the pattern length L becomes shorter at points A, C, E and G on the circumference of the track, while the flying height goes down and the pattern length L becomes longer at points B, D, F and H. In the examples shown in FIGS. 2(A) and 2(B), the flying height varies in an accurate cycle over one round of the flying height. However, in fact, the cycle of the pattern length which varies during one round of the track varies. The variation tendency of the flying height related to the flatness of the magnetic disk appears as an identical tendency even if the tendency related to one track is an adjacent track. Further, the substantially same tendency is exhibited from the inner peripheral track toward the outer peripheral track among the variation of the flying height related to the flatness of the magnetic disk. The present invention can also deal with a case in which the variation pattern of the flying height is different depending on the radial position of the magnetic disk.

One of the burst patterns of servo information to be written in the servo sector of the magnetic disk is called “seamed pattern”. FIG. 3 shows an example of the seamed pattern that is written in three servo sectors of (A), (B) and (C) arranged on the same servo track. The seamed pattern is written in such a manner that edges of a main burst pattern A and a main burst pattern B which are adjacent to each other in a zigzag in each of the servo sectors are arranged on the centers 101, 105 and 109 of the main burst pattern as shown in FIG. 3. Also, the seamed pattern is written so that the edges of a sub burst pattern C and a sub burst pattern D are arranged on the centers 103 and 107 of the burst patterns.

When track following control is conducted by using the seamed pattern, the position of the edge of the main burst pattern in the radial direction of the disk is important because the center of the main burst pattern is used. Because the sub burst pattern is also used instead of the main burst pattern when the variation amount of a positional error signal (hereinafter referred to as “PES”) obtained from the main burst pattern is lowered, the position of the edge in the radial direction of the disk is important likewise. A writing method of the seamed pattern is disclosed in Japanese Patent Laid-open No. 2004-87039. A method of writing the seamed pattern shown in FIG. 3 will be described with reference to FIG. 4.

In FIG. 4, a vertical direction is indicative of the radial direction of the disk, and a lower side is an inner peripheral side of the magnetic disk. The pattern length L that is written in the magnetic layer by the write head is wider than a final pattern width of the respective burst patterns in the radial direction of the disk. First, a burst pattern A1 including a filled portion is written in the servo sectors that are discretely arranged in the circumferential direction in order. Then, the write head is moved toward an outer peripheral track side by half pitch of the respective burst patterns, and a burst pattern Cl is written.

Then, the write head is moved toward the outer peripheral track side by the half pitch, and a burst pattern B1 is written. In this situation, the write head erases the filled portion of the burst pattern A1 with a DC erase and writes so as to align the positions of the edges of the patterns A1 and B1 together. A timing of writing the burst pattern B1 is controlled, and the burst pattern C1 that has already been written is not overwritten. In addition, the write head is moved toward the outer peripheral track side by the half pitch, and the burst pattern D1 is written. In this situation, the write head erases the filled portion of the burst pattern C1 with a DC erase and writes so as to align the positions of the edges of the burst pattern C1 and the burst pattern D1 together.

A timing of writing the burst pattern D1 is controlled, and the burst pattern B1 that has already been written is not overwritten. The same procedure is repeated, and the write head erases an excessive region of the burst patterns that have already been written with a DC erase, and writes new burst patterns while aligning the positions of the edges together. When the seamed pattern is written while aligning the positions of the edges with the DC erase as described above, if the flying height of the head/slider varies, the centers of the burst patterns between the respective servo sectors are not aligned together.

FIG. 5 is a diagram for explaining a state in which the flying height of the head/slider varies when the burst pattern shown in FIG. 3 is written in the procedure described with reference to FIG. 4. The flying height of the head/slider when writing the burst pattern in the servo sector of (B) is lower than that when writing the burst pattern in the servo sectors of (A) and (C). Accordingly, the pattern length L of (B) is longer than the pattern length L1 of (A) and (C). As a result, lines 101 and 105 that connect the edges of the burst patterns A1 and B1 in (A), (B) and (C) by the servo sectors, respectively, are warped with respect to a perfect circle because the edge of the burst pattern that is written in the servo sector of (B) is shifted downward (inner peripheral track side).

FIG. 6 shows lines that connect the respective edges of the burst patterns corresponding to the respective servo sectors over the circumferential direction of the magnetic disk in the seamed pattern that is written through the self head servo write system. A line 107 represents a case in which the flying height of the head/slider does not vary while the burst pattern is written. A line 109 represents a case in which the flying height of the head/slider is lowest in positions P1 and P3 of the magnetic disk in the circumferential direction while the burst pattern is written. As described above, the variation of the flying height of the head/slider causes the line that connects the respective edges to each other over one round of the servo track to cyclically vary in the radial direction when the seamed pattern is written through the self head servo write system.

The head/slider conducts track following operation along the line 109. In this case, when the head/slider is positioned in the center of a specific track, for example, at a position P1, if the magnetic disk rotates and the position P2 goes immediately below the read head, PES that means that the head/slider is deviated from the center of the track is generated from the reproduction signal of the burst pattern. As a result, the servo control circuit controls the position of the head/slider so that the head/slider goes toward the center of the track. The head/slider is not located at the center of the track or at a position within a permissible range from the center during the above operation. Thus, a precision in the track following operation is deteriorated, thereby causing a recording or reproduction error to occur or deteriorating the recording or reproduction operation time.

Under the above circumstances, a feature of the present invention is to provide a method of writing, in a servo sector, a seamed pattern whose edge is not shifted in a radial direction of a magnetic disk even if the flying height of a head/slider varies when servo data is recorded through a self head servo write system. Another feature of the present invention is to provide a method of controlling a recording current which can stably record data even if a flying height varies. Still further, a feature of the present invention is to provide a magnetic disk that executes the above methods.

The present invention solves problems which will be caused when a pattern length recorded in the magnetic disk by the write head varies due to a variation of the flying height of the head/slider by controlling a current to flow in the write head on the basis of a variation pattern signal of the flying height.

According to a first aspect of the present invention, there is provided a method of writing a seamed pattern of servo data using a write head equipped in a magnetic disk drive comprising the steps of: generating a variation pattern signal of flying height in a circumferential direction of the magnetic disk; positioning the write head at a given position of the magnetic disk; and writing the seamed pattern while controlling a recording current to be supplied to the write head on the basis of the variation pattern signal.

The method of writing servo data by the write head equipped in the magnetic disk drive includes a self servo write system and a method using an external device such as a servo track writer. A variation pattern signal indicative of a variation state of the flying height of the magnetic disk in the circumferential direction can be generated from the reproduction signal of a gain adjustment pattern of provisional servo data or seamless pattern. Also, the variation pattern signal can be generated by irradiating the magnetic disk surface with a laser beam or infrared rays.

In the case where the variation pattern signals are generated at plural positions of the magnetic disk in the radial direction thereof, even if the variation pattern of the flying height is different in the radial direction of the magnetic disk, a high-precision seamed pattern can be written by using the variation pattern signal that has been generated at an adjacent track position. Since a recording current that is controlled on the basis of the variation pattern signal is supplied to the write head, the pattern length can be suppressed from being shorter by increasing the recording current at positions where the flying height is high, and the pattern length can be suppressed from being longer by decreasing the recording current at positions where the flying height is low. With the above structure, even if the flying height varies, the pattern length that is recorded in the magnetic disk can fall within a constant range, and the positions of the edges can be accurately determined when the seamed pattern is written.

According to a second aspect of the present invention, there is provided a method of recording user data in a magnetic disk, the method comprising the steps of: generating and recording a variation pattern of flying height in a circumferential direction of the magnetic disk; positioning the write head at a given position of the magnetic disk; and recording the user data while controlling a recording current to be supplied to the write head on the basis of the recorded variation pattern. According to this aspect, even if the flying height varies when the user data is recorded in the magnetic disk, the pattern length can be controlled to a constant length range. Further, it is possible to obtain stable reproduction data and reduce an influence of data on the adjacent track.

According to a third aspect of the present invention, there is provided a magnetic disk drive including a write head, a read head, and a magnetic disk, wherein a seamed pattern of servo data is written in the magnetic disk by the write head, the magnetic disk drive comprising: a servo pattern transfer section that transfers a write signal of the seamed pattern; a variation pattern generating section that reproduces provisional servo data written in the magnetic disk and generates a variation pattern signal of flying height in a circumferential direction of the magnetic disk; a recording current control section that generates a recording current control signal on the basis of the variation pattern signal; and a recording current generating section that converts a write signal of the seamed pattern received from the servo pattern transfer section into a recording current to be supplied to the write head under control according to the recording current control signal received from the recording current control section.

According to a fourth aspect of the present invention, there is provided a magnetic disk drive including a write head, a read head, and a magnetic disk, the magnetic disk drive comprising: a user data transfer section that transfers a recording signal generated from user data, the user data being transmitted from a host computer; a variation pattern recording section that records a variation pattern signal of flying height in a circumferential direction of the magnetic disk, the variation pattern signal being generated from a reproduction signal of a seamless pattern written in the magnetic disk; a recording current control section that generates a recording current control signal on the basis of the variation pattern signal; and a recording current generating section that converts a recording signal received from the user data transfer section into a recording current to be supplied to the write head under control according to the recording current control signal received from the recording current control section.

According to the present invention, there can be provided a method of writing, in the servo sector, the seamed pattern whose edge is not shifted in the radial direction of the magnetic disk even if the flying height of the head/slider varies when servo data is recorded by using the self head servo write system. In addition, according to the present invention, there can be provided a method of controlling the recording current that can stably record data even if the flying height varies. Further, according to the present invention, there can be provided a magnetic disk device that executes the above methods.

### BRIEF DESCRIPTION OF THE DRAWINGS

FIG. 1 is a diagram showing the flow of a magnetic flux when data is recorded in a magnetic disk with an induction recording head.

FIG. 2 is a diagram for explaining a state in which the flying height of a head/slider is varied, and a pattern length is varied.

FIG. 3 is a diagram showing an example of seamed patterns that are written in servo sectors.

FIG. 4 is a diagram for explaining a method of writing the seamed patterns.

FIG. 5 is a diagram for explaining a state in which the flying height is varied at the time of writing the seamed patterns.

FIG. 6 is a diagram for explaining a state in which the flying height is varied at the time of writing the seamed patterns.

FIG. 7 is a diagram showing a format of the magnetic disk according to an embodiment of the present invention.

FIG. 8 is a partially enlarged diagram showing the format of the magnetic disk.

FIG. 9 is a diagram showing the structure of the seamless patterns that are written in the data sectors.

FIG. 10 is a flowchart showing a procedure in which the seamed pattern is written through the self servo write type.

FIG. 11 is a block diagram showing a main portion of the magnetic disk drive that writes the seamed pattern.

FIG. 12 is a diagram sowing an example of the variation pattern signal that is calculated as VP.

FIG. 13 is a diagram for explaining a method of generating a recording current control signal.

FIG. 14 is a block diagram showing the main structure of a head signal reproducing section.

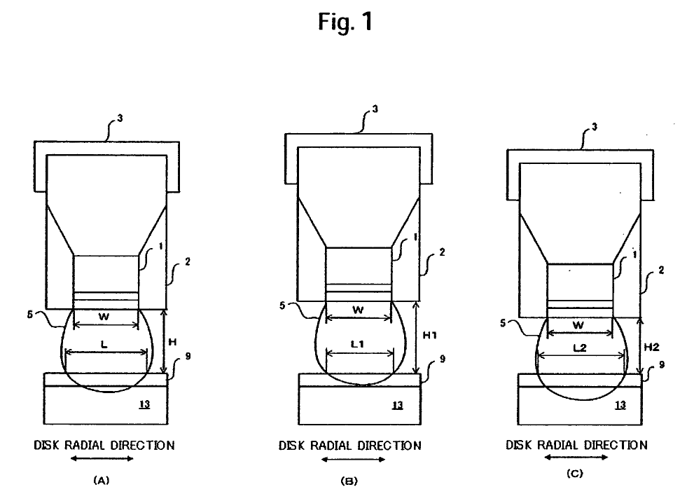

### DETAILED DESCRIPTION OF THE INVENTION

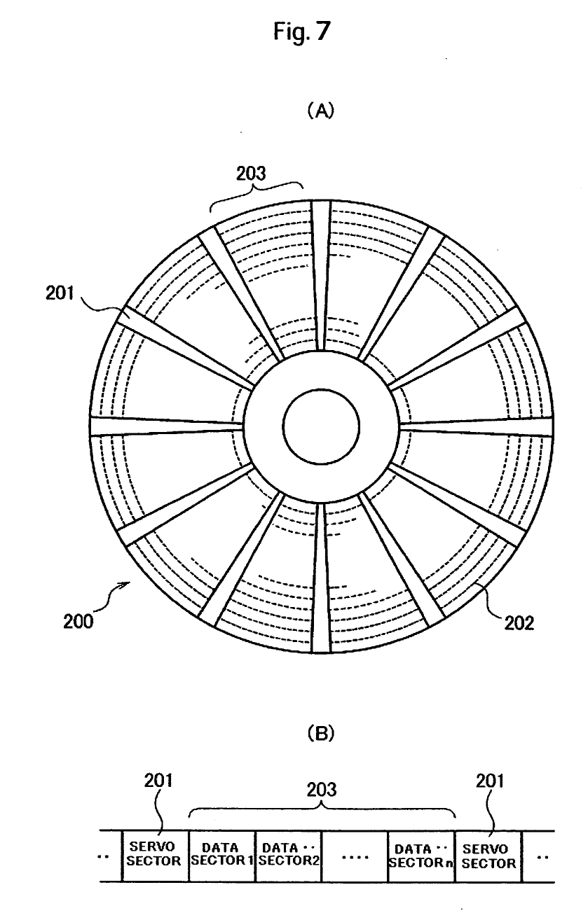

FIG. 7 is a diagram showing a format of a magnetic disk according to an embodiment of the present invention. A magnetic disk 200 is used in a magnetic disk drive using a data surface servo system. In the data surface servo system, in the case where one or plural magnetic disks are disposed in one magnetic disk drive, and a plurality of recording surfaces exist in the magnetic disk, the respective recording surfaces are identical with each other in structure. As shown in FIG. 7(A), the 100 to 200 servo sectors 201 are disposed radially over the outer peripheral tracks from the inner peripheral tracks on the recording face of the magnetic disk 200, for example, and the servo data is recorded in the respective servo sectors 201. The servo sectors 201 and the date regions 203 are alternately disposed in the circumferential direction of the magnetic disk.

Also, the data regions 203 of the magnetic disk 200 is defined with a plurality of data tracks 202 (hereinafter referred to simply as “tracks”) disposed concentrically. The tracks 202 are disposed in a region through which the write head or the read head passes. The write head or the read head is located at a predetermined position in the radial direction of the magnetic disk 200 on the basis of the positional information of the magnetic head which is reproduced from the servo data. As shown in FIG. 7(B), the data regions 203 each include n data sectors which are defined, for example, as data recording regions of 512 bytes.

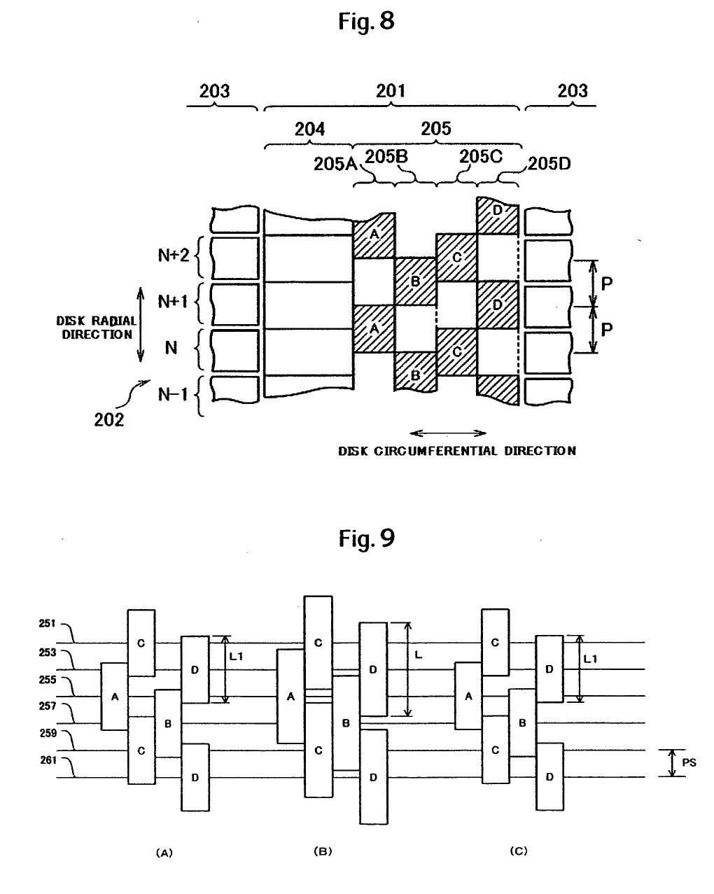

FIG. 8 is a partially enlarged diagram showing a format of the magnetic disk 200 shown in FIG. 7. In FIG. 8, there are shown a track N−1, a track N, a track N+1, and a track N+2 which are defined in the data regions 203, and servo sectors 201 adjacent to those tracks in the circumferential direction of the magnetic disk. Each of the servo sectors 201 includes an identification information region 204 and a burst pattern region 205. The burst pattern region 205 is provided with main burst pattern arrays 205A and 205B and sub burst pattern arrays 205C and 205D, which are arranged along the radial direction of the magnetic disk 200, respectively. The respective burst pattern arrays 205A, 205B, 205C and 205D are made up of seamed patterns A, B, C and D which are written such that the dimensions of the magnetic disk in the radial direction are identical with each other.

The main burst pattern arrays 205A and 205B are written at a position where the phases of the reproduction signals are shifted from each other by 180 degrees when the head is moved in the radial direction of the disk, and constitute the main burst patterns. In addition, the sub burst pattern arrays 205C and 205D are written at a position where the phases of the reproduction signals are shifted from each other by 180 degrees when the head is moved in the radial direction of the disk, and constitute the sub burst patterns. The main burst patterns and the sub burst patterns are written in such a manner that the phases of the reproduction signals are shifted from each other by 90 degrees. The dimensions of the respective burst patterns in the radial direction of the disk, that is, the pitches of the burst patterns are equal to track pitches P or substantially equal to the width of the tracks 202.

In the present specification, the position in the radial direction of the disk where the main burst patterns A and the main burst patterns B mutually transit each other is called “center of the main burst pattern”, while the position in the radial direction of the disk where the sub burst patterns C and the sub burst patterns D mutually transit each other is called “center of the sub burst pattern.” Also, the center of the track width is called “center of the track.” A servo sector start code is recorded in the head of the identification information region 204. Also, a gray code (cyclic binary code) indicative of the track identification No. as the identification information of the servo sector, and a code indicative of physical identification No. of the servo sector 201 are recorded in the identification information region 204, respectively.

There are various methods for positioning the write head in order to realize the self head servo write system. Although it is unnecessary that the present invention is limited to any one of those methods, the present invention applies a method of using the provisional servo data that is recorded in the data region. The provisional servo data is recorded in the sector of the data regions 203 through a known method. The provisional servo data includes the track information that defines the position in the radial direction, the sector information that defines the position in the circumferential direction, and the gain adjustment patterns. The provisional servo data also includes the seamless pattern which is a burst pattern used for the track following control.

FIG. 9 shows a structure of the seamless pattern of the provisional servo data that is written in the data sector. Four seamless patterns A, B, C and D have the phases of the reproduction signals shifted from each other by 90 degrees when the read head travels in the radial direction. The seamless pattern is written discretely at uniform rates in the circumferential direction of the magnetic disk, and written in the radial direction with the pitch PS. FIG. 9 shows the seamless patterns that are written in three user sectors (A), (B) and (C) in the circumferential direction. The center of the write head is positioned to the center lines 251, 253, 255, 257, 259 and 261 of the patterns to sequentially write the seamless patterns A, B, C and D from the inner peripheral side or the outer peripheral side of the magnetic disk with the pitch PS. This writing operation uses signals resulting from reproducing the patterns that have already been written.

In the case where the read head is positioned, for example, on the center line 257 by using the seamless pattern, a current in a voice coil motor is controlled so that PES calculated on the basis of (VA-VC)/VB becomes zero assuming that voltages that are used to reproduce the burst patterns A, B and C are VA, VB and VC, respectively. Accordingly, for the seamless patterns, it is important in the positional control of the head that the respective patterns are written in such a manner that the center of the head is on the respective center lines. In FIG. 9, the flying height of the head/slider is deteriorated at the position (B), where the pattern length L becomes longer than the pattern length L1 of the position (A) or the position (B).

However, so far as the center of the write head is on the center lines 251 to 261 of the respective patterns when writing the patterns, PES obtained by calculating expression of (VA-VC)/VB does not vary even if the pattern length varies. In other words, the seamless pattern is hardly affected by the variation of the flying height of the head/slider which occurs at the time of writing through the self head servo write system.

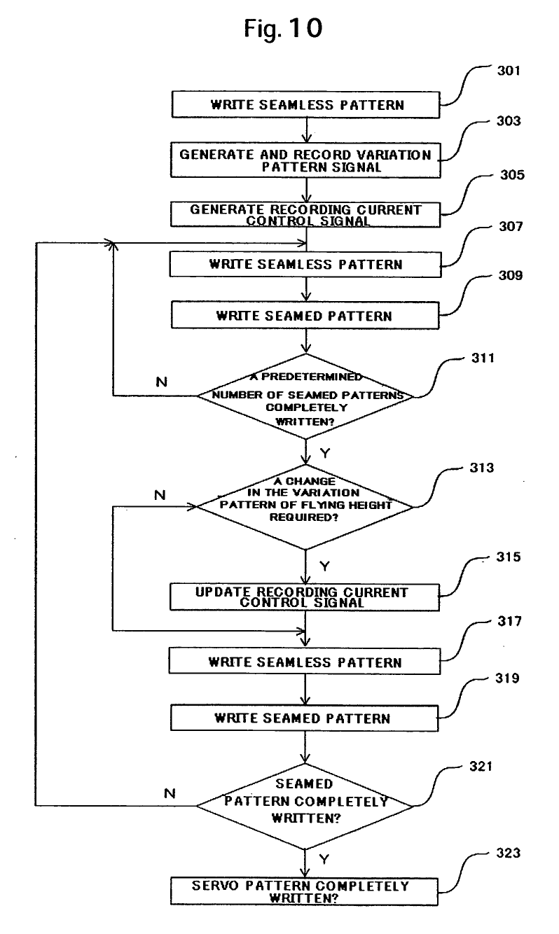

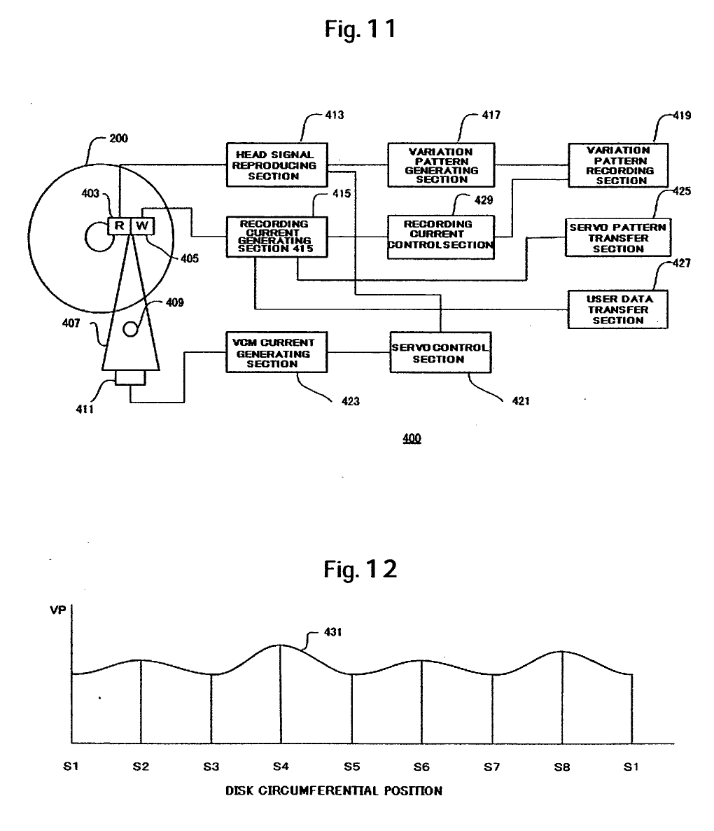

Subsequently, a description will be given of a method of writing the seamed patterns in the servo sector through the self servo write system according to an embodiment of the present invention with reference to FIGS. 10 and 11. FIG. 10 is a flowchart showing a write procedure, and FIG. 11 is a block diagram showing a main portion of a magnetic disk drive according to the embodiment of the present invention. Referring to FIG. 11, a magnetic disk drive 400 includes a magnetic disk 200 as described in FIG. 7, a GMR read head 403, an induction write head 405, a head moving mechanism 407, and a voice coil motor 411. The GMR read head 403 and the induction write head 405 are formed on the same slider, and constitutes a head/slider in cooperation with the slider. The head moving mechanism 407 is driven by the voice coil motor (hereinafter referred to as “VCM”), pivotally moves about a pivot shaft 409, and positions the head/slider to a given track.

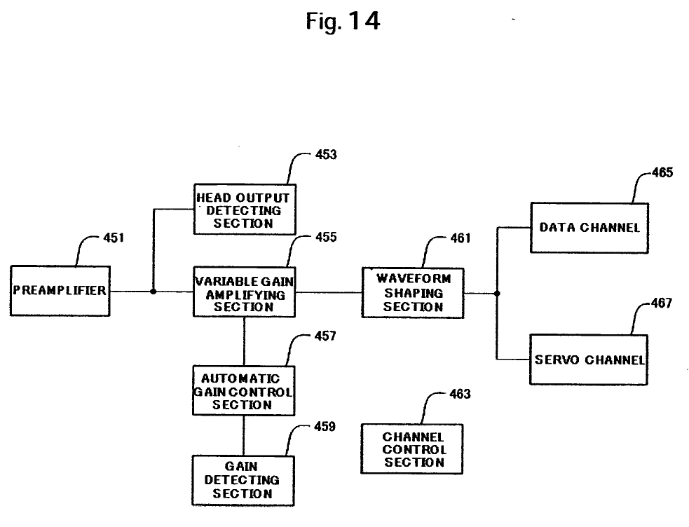

A head signal reproducing section 413 will be described with reference to a block diagram of FIG. 14. A preamplifier 451 is attached to the head moving mechanism 407. The preamplifier 451 amplifies a weak analog reproduction signal that has been reproduced by the read head 403, and transmit the reproduction signal to a variable gain amplifying section (hereinafter referred to as “VGA”) 455. The VGA 455 amplifies the reproduction signal of the head which has been amplified by the preamplifier 451 by a gain value set by an automatic gain control section (hereinafter referred to as “AGC”) 457. To generate the variation pattern signal, the head output detecting section 453 detects the reproduction signal obtained by allowing the read head to reproduce the burst pattern of the provisional servo data which has been written in the user sector, and then transmits the detected reproduction signal to the variation pattern generating section 417 (FIG. 11).

The AGC 457 measures an output of the VGA 455. The AGC 457 changes the gain if a difference occurs between the measured value and a reference value, and operates such that the output of the VGA 455 is kept constant. When the reproduction signal is user data, the AGC 457 follows a change in the signal level of the reproduction signal under feedback control based on digital processing and automatically adjusts its gain so that the amplitude of the reproduction signal that has been amplified by the VGA 455 is within a constant range. When the reproduction signal is servo data, the AGC 457 determines the gain on the basis of the preamble that is a gain adjustment pattern which has been written in the head portion of the servo data, and amplifies the servo data related to the positional information of the head subsequent to the preamble according to the determined gain.

A gain detecting section 459 is provided in order to generate a signal for generating the variation pattern signal instead of the head output detecting section 453. The gain detecting section 459 detects from the AGC 457 the gain value of the VGA 455 which has been set in reproducing the preamble of the servo data, converts the detected gain value into a digital value, and transmits the converted digital value to the variation pattern generating section 417 (FIG. 11). Because the AGC 457 controls the gain so that the output of the VGA 455 is kept constant, the gain value increases according as the flying height of the head/slider rises at the time of reproduction. Accordingly, the gain value of the VGA 455 which has been determined at the time of reproducing the servo data can be utilized to generate the variation pattern.

A waveform shaping section 461 shapes the waveform of the reproduction signal that has been amplified by the VGA 455. A data channel 465 includes an AD converter, a serial/parallel converter, a data modulator, a data demodulator, and an error correction circuit. The waveform shaping section 461 converts the reproduction signal that is reproduced from the data sector of the data region 203 into a data signal that can be read by a host computer, and converts the data signal that has been received from the host computer into a recording signal. The operation of the data channel 465 is controlled by a channel control section 463 in response to a read gate signal or a write gate signal. A servo channel 467 includes a gray code demodulating section, a positional information demodulating section, and a SAM detecting section. The gray code demodulating section decodes a gray code that has been subjected to waveform shaping by the waveform shaping section 461, and thereafter converts the decoded gray code into a digital signal by the AD converter. Then, the gray code demodulating section outputs the digital signal to the servo control section 421 (FIG. 11) to notify the positional information of the track which is reproduced by the read head. The positional information demodulating section reproduces the burst pattern that has been subjected to waveform shaping by the waveform shaping section 461, converts into a digital value using the AD converter a value peak-held at a timing of the position where the respective burst patterns are written, and then transmits the digital signal to the servo control section 421.

The SAM detecting section detects SAM from the reproduction signals of the servo data, and transmits the SAM to the channel control section 463 every time the SAM detecting section detects the SAM. The channel control section 463 controls the entire operation of the head signal reproducing section. The channel control section 463 transmits a channel timing signal to the AGC 457 at a periodic cycle where the head/slider reaches a position at which the servo data is arranged to thereby start gain control.

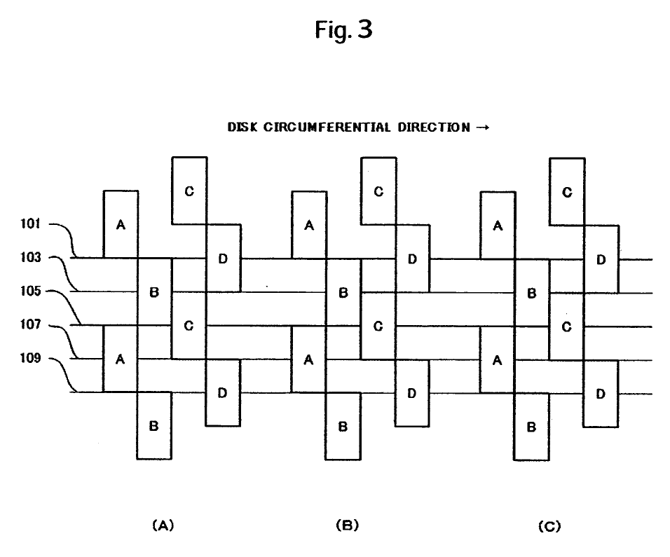

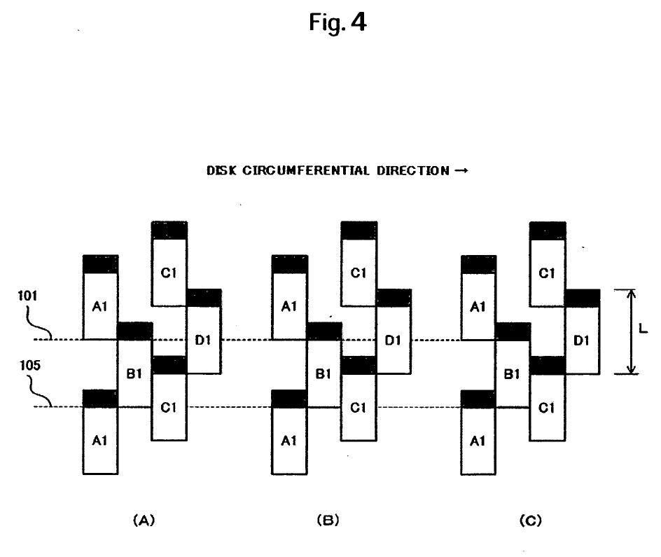

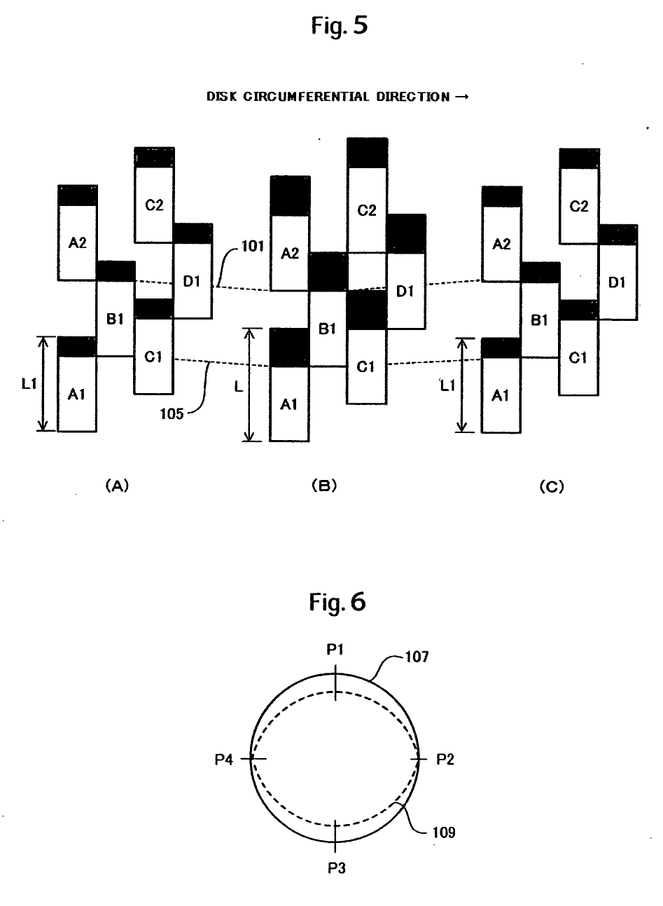

By executing the procedure shown in FIG. 10, the servo data including the seamed pattern described in FIG. 3 is written in the servo sectors of the magnetic disk 200, while the provisional servo data including the seamless pattern described in FIG. 9 is written in the user sectors. It is unnecessary to write the provisional servo data in all of the user sectors. The provisional servo data is written radially over the entire magnetic disk in the radial direction similar to the servo data in the servo sectors. The data that is reproduced by the read head 403 includes the servo data that has been written in the servo sectors and the user data that has been recorded in the user sectors. In addition, to execute the self servo write system, the data that is reproduced by the read head includes the provisional servo data that has been written in the user sector.

Returning to FIG. 11, the variation pattern generating section 417 generates the variation pattern signal indicative of the variation pattern of the flying height of the head/slider. This variation pattern varies over one round of an arbitrary track of the magnetic disk. To generate the variation pattern signal, the variation pattern generating section 417 receives the reproduction signal at the time of reproducing the seamless pattern of the provisional servo data from the head output detecting section 453 included in the head signal reproducing section 413.

For example, assuming that voltages used to reproduce from the seamless patterns A to D in FIG. 9 are VA to VD, the read head is positioned at the center line 257 of the pattern shown in FIG. 9 to calculate an elapse time from a reference point over one round of the track or VP=VA+VC with respect to the circumferential position of the track. The variation pattern generating section 417 receives a timing signal from the channel control section 463, and then recognizes the reproduction signals of the individual burst patterns that are transmitted from the head output detecting section 453.

Alternatively, the variation pattern generating section positions the read head to the center line 255, and then calculates VP=VB+VD, likewise. The variation pattern signal 431 that has been calculated as VP is shown in FIG. 12. In FIG. 12, the axis of abscissa represents a position of the magnetic disk 200 over one round in the circumferential direction, and the axis of ordinate represents VP. The value of VP exhibits a maximum value at positions S2, S4, S6 and S8, and the value of VP exhibits a minimum value at positions S1, S3, S5 and S7. To generate the variation pattern, the variation pattern generating section 417 may receive the gain value of the AGC 457 from the gain detecting section 459 of the head signal reproducing section 413 at the time of reproducing the seamless pattern. To generate the variation pattern signal, a signal obtained by reproducing the gain adjustment pattern for adjusting the AGC gain that is written in the center of the seamless pattern may be employed instead of the reproduction signal of the seamless pattern.

As is apparent from the characteristics of the seamless pattern described in FIG. 9, the flying height of the head/slider at the position where VP exhibits the maximum value at the time of writing the seamless pattern is lower than that of the surrounding positions. Also, the flying height of the head/slider at the position where VP exhibits the minimum value at the time of writing the seamless pattern is higher than that of the surrounding positions. Accordingly, the variation pattern signal 431 can be used as a substitute characteristic of the flying height.

The provisional servo data includes the positional information (index data) in the radial direction and the circumferential direction and the gain adjustment pattern described above. The provisional servo data is written on the center line of the seamless pattern. The variation pattern recording section 419 records the variation pattern signal 431 that is generated by the variation pattern generating section 417 together with the index information. The variation pattern recording section 419 may record the variation pattern signal 431 that has been generated at plural positions of the magnetic disk 200 in the radial direction by the variation pattern generating section 417.

The recording current generating section 415 includes a write driver. The recording current generating section 415 converts a digital signal that is recorded in the magnetic disk into a recording current to flow in the write head 405. The write drive can change a value of a register equipped therein, thereby making it possible to change a fundamental wave and overshoot component of the recording current. The recording current control section 429 generates a recording current control signal used to change the setting value of a register in the recording current generating section 415 on the basis of the variation pattern signal 431 that has been received from the variation pattern recording section 419.

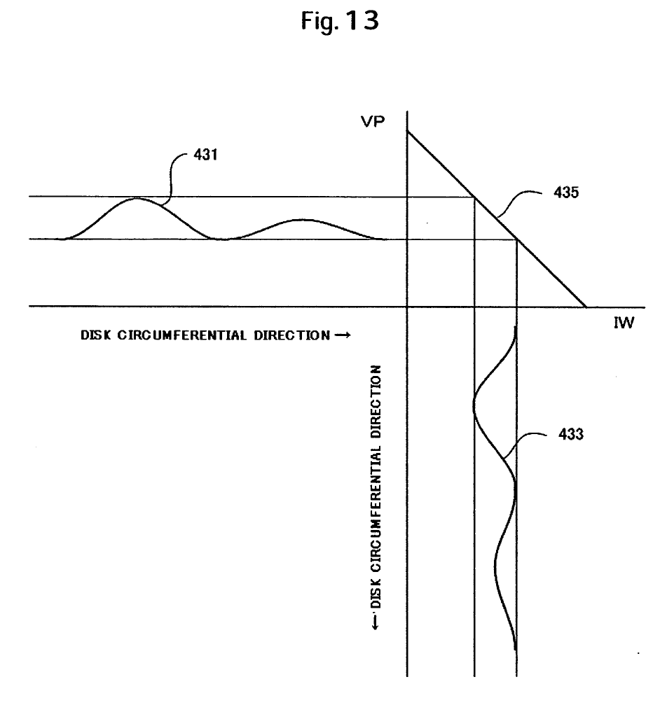

The recording current control signal is a digital signal for continuously controlling the magnitude of the recording current in response to the level of the flying height of the head/slider. The larger VP of the variation pattern signal 431, the smaller the recording current control signal, whereas the smaller VP, the larger the recording current control signal. As one example, a method of generating the recording current control signal 433 from the variation pattern signal 431 will be described in FIG. 13. The recording current control signal 433 is converted, from the variation pattern signal 431, and generated by a line 435 indicative of a conversion characteristic with which VP and the recording current IW are converted. To obtain optimum IW that makes the pattern length constant with respect to the varying VP, experiments are repeated, thereby making it possible to appropriately select an inclined angle of the line 435 or to select an expression of two or more dimensions instead of a one-dimensional expression of the line.

The servo pattern transfer section 425 generates a digital signal used to write the seamless pattern and the seamed pattern, or receives those patterns from an external device and transfers the patterns to the recording current generating section 415. The user data transfer section 427 adds an error correction code (ECC) to the user data transmitted from the host computer or modulates the user data to generate a recording signal to be recorded in the magnetic disk, and thereafter transfers the recording signal to the recording current generating section 415. The servo control section 421 calculates the present position of the head on the basis of the reproduction signal of the servo data or the reproduction signal of the provisional servo data which has been received from the head signal reproducing section 413, generates a servo signal for moving or following the head/slider to a target position, and transmits the servo signal to the VCM current generating section 423. The VCM current generating section 423 converts the digital servo signal that has been received from the servo control section 421 into a current to be supplied to a voice coil of the VCM 411.

Subsequently, a description will be given of a procedure of writing the seamed pattern in the servo sectors of the magnetic disk 200 through the self servo write system with reference to a flowchart of FIG. 10. In block 301, the provisional servo data including the index information and the seamless pattern is written in the user sectors through a known method. For example, the head moving mechanism 407 is moved until the head moving mechanism 407 is abutted against a crush stop at the innermost circumferential track side to decide the reference position of the innermost circumferential side, and a first seamless pattern is written therein. Then, the head/slider is located at a position that is shifted toward the outer circumferential track side in response to a positional signal obtained by reproducing and calculating the signal of the first seamless pattern to write a subsequent seamless pattern therein. A signal for writing the seamless pattern is transmitted to the recording current generating section 415 from the servo pattern transfer section 425.

In block 303, by reproducing the seamless pattern of the written provisional servo data, the variation pattern generating section 417 generates the variation pattern signal of the flying height and transmits the variation pattern signal to the variation pattern recording section 419. The variation pattern recording section 419 records the variation pattern signal received. In block 305, the recording current control section 429 generates the recording current control signal on the basis of the variation pattern signal that has been received from the variation pattern recording section 419. In block 307, the head/slider is further shifted to write the seamless pattern. Then, after a pair of seamless patterns are written, the servo data including the identification information and the seamed pattern is written in the servo sectors in block 309 by using the reproduction signal of the seamless pattern for positioning of the head/slider.

When writing the seamed pattern, the recording current control section 429 receives the variation pattern signal from the variation pattern recording section, generates the recording current control signal, and transmits the recording current control signal to the recording current generating section 415. The recording current generating section 415 receives a signal used to write the seamed pattern from the servo pattern transfer section 425. The recording current generating section 415 writes the seamed pattern in the servo sectors which are discretely arranged in the circumferential direction of the magnetic disk while the recording current to be supplied to the recording head 405 is changed according to the value of the register in which the recording current control signal generated by the recording current control section 429 has been written. As a result, the seamed pattern is written with a large recording current at positions where the flying height is higher. On the other hand, the seamed pattern is written with a small recording current at positions where the flying height is lower. This makes it possible to fall the pattern length within a constant range and accurately define the position of the edge.

In block 311, it is judged whether or not a given number of seamed patterns have been written in the radial direction of the magnetic disk. A purpose of judgment is to deal with a case where the variation pattern changes at a position of the magnetic disk in the radial direction. After the given number of the seamed patterns are written, processing is shifted to block 313. As in block 303, the variation pattern generating section 417 generates a new variation pattern signal, and the variation pattern recording section 419 records the new variation pattern signal together with the index information. In addition, when a difference between the variation pattern signal generated immediately before and the new variation pattern signal is equal to or more than a given value, a recording current control signal is generated and updated on the basis of the new variation pattern signal in block 315.

In block 317, the seamless pattern is further written, and the recording current control section 429 controls the recording current generating section 415 according to the updated recording current control signal. The servo control section 421 positions the head/slider according to a signal obtained by reproducing the seamless pattern. The recording current generating section 415 supplies the recording current used to write the seamed pattern to the recording head 405 to write the seamless pattern in block 317. When it is unnecessary to change the variation pattern signal of the flying height in block 313, a subsequent seamless pattern is written in block 317. The seamed pattern is written by the recording current which is controlled according to the recording current control signal that is generated from the previous variation pattern signal in block 319.

The seamless pattern is written in order from the inner circumferential side of the magnetic disk toward the outer circumferential side, and the seamed pattern is written while the head/slider is positioned according to the written seamless pattern. Since the magnitude of current at the time of write is controlled by the recording current control signal that has been generated from the variation pattern signal, the write current of the seamed pattern is controlled according to a change in the flying height. The variation pattern signal is generated and recorded at each of given positions in the radial direction of the magnetic disk, and updated if necessary. In block 321, it is judged whether or not the servo data has been recorded in given servo sectors. In block 323, writing the servo data including the seamed pattern is complete. Thereafter, the provisional servo data that has been written in the user sectors is overwritten with the user data and disappears.

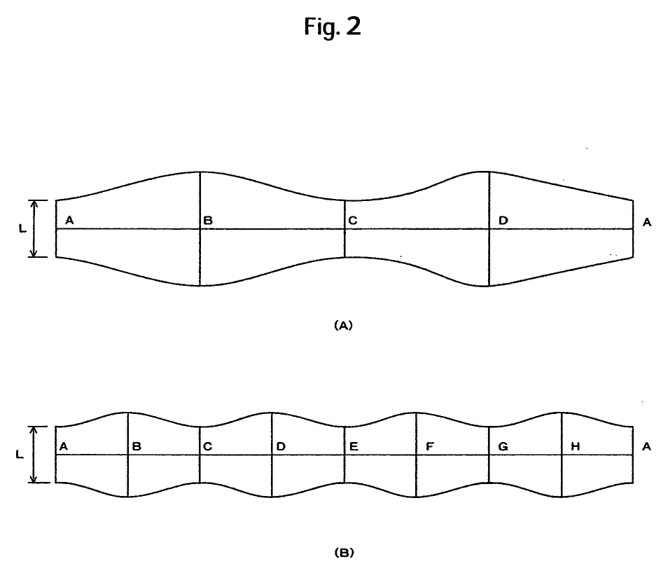

The above description is given of the procedure of recording the seamed pattern in the servo sectors through the self servo write system. A method of controlling a current that is supplied to the recording head according to the present invention can be used to record the user data in the user sectors. As described in FIG. 2, when the pattern length of the user data which has been recorded in the magnetic disk is shortened with a variation of the flying height, the reproduction signal is deteriorated. When the pattern length is lengthened, there is the possibility that data that has been written in the adjacent tracks is affected. Therefore, it is desirable to keep the pattern length within a constant range. At the time of writing the seamed pattern, a plurality of variation patterns calculated from the seamless patterns that are reproduced at a plurality of positions in the radial direction of the magnetic disk are recorded in the variation pattern recording section 419.

For user data recording when the recording current control section 429 records the user data that has been transmitted from the user data transfer section 427 in the magnetic disk while controlling the recording current generating section 415 according to the recording current control signal that has been generated from the variation pattern, it is possible to fall the pattern length of the user data within a constant range. The data track of the magnetic disk is divided into a plurality of zones that are set in the radial direction, and the variation pattern signals are recorded in each of those zones. In this case, when the recording current control signal is generated, at the time of user data recording, according to the variation pattern signal of the zones to which a certain track belongs to control the recording current, it is possible to precisely control the pattern length even if the variation pattern is changed in the radial direction of the magnetic disk.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

What is claimed is:

1. A method of writing a seamed pattern of servo data using a write head equipped in a magnetic disk, the method comprising:
generating a variation pattern signal of flying height in a circumferential direction of the magnetic disk;
positioning the write head at a given position of the magnetic disk; and
writing the seamed pattern while controlling a recording current to be supplied to the write head on the basis of the variation pattern signal.

2. The writing method according to claim 1, wherein the variation pattern signal of the flying height is generated from a reproduction signal of provisional servo data which is written in a user sector of the magnetic disk.

3. The writing method according to claim 2, wherein the provisional servo data includes a seamless pattern including a pair of burst pattern A and burst pattern B, and generating the variation pattern signal of the flying height includes calculating VP=VA+VB where a voltage when a read head that is located midway between the burst pattern A and the burst pattern B reproduces the burst pattern A is VA, and a voltage when the read head reproduces the burst pattern B is VB.

4. The writing method according to claim 3, wherein writing the seamed pattern includes reducing the recording current at a position where VP is larger with respect to the recording current at a position where VP is smaller.

5. The writing method according to claim 1, wherein generating the variation pattern signal of the flying height includes generating the variation pattern signal at a plurality of positions in a radius direction of the magnetic disk.

6. The writing method according to claim 1, wherein the magnetic disk drive positions the write head by the use of a self servo write system.

7. The writing method according to claim 1, wherein the magnetic disk drive positions the write head by the use of a servo track writer.

8. A method of recording user data in a magnetic disk, the method comprising:
generating and recording a variation pattern of flying height in a circumferential direction of the magnetic disk;
positioning the write head at a given position of the magnetic disk; and
recording the user data while controlling a recording current to be supplied to the write head on the basis of the recorded variation pattern.

9. The recording method according to claim 8, wherein the variation pattern signal of the flying height is generated from a reproduction signal of provisional servo data which is written in a user sector of the magnetic disk.

10. The writing method according to claim 9, wherein the provisional servo data includes a seamless pattern including a pair of burst pattern A and burst pattern B, and generating the variation pattern signal of the flying height includes calculating VP=VA+VB where a voltage when a read head that is located midway between the burst pattern A and the burst pattern B reproduces the burst pattern A is VA, and a voltage when the read head reproduces the burst pattern B is VB.

11. The recording method according to claim 1, wherein generating and recording the variation pattern signal of the flying height includes generating and recording the variation pattern signal in each of a plurality of zones that are set in a radius direction of the magnetic disk.

12. A magnetic disk drive including a write head, a read head, and a magnetic disk, wherein a seamed pattern of servo data is written in the magnetic disk by the write head, the magnetic disk drive comprising:
a servo pattern transfer section that transfers a write signal of the seamed pattern;
a variation pattern generating section that reproduces provisional servo data written in the magnetic disk and generates a variation pattern signal of flying height in a circumferential direction of the magnetic disk;
a recording current control section that generates a recording current control signal on the basis of the variation pattern signal; and
a recording current generating section that converts a write signal of the seamed pattern received from the servo pattern transfer section into a recording current to be supplied to the write head under control according to the recording current control signal received from the recording current control section.

13. The magnetic disk drive according to claim 12, further comprising a head output detecting section that transmits a reproduction signal reproduced by the read head to the variation pattern generating section.

14. The magnetic disk drive according to claim 12, further comprising a gain detecting section that transmits a gain value of an automatic gain amplifying section set for a variable gain amplification section to the variation pattern generation section, said variable gain amplification section amplifying a reproduction signal which is reproduced by the read head.

15. The magnetic disk drive according to clam 12, further comprising a variation pattern recording section that records the variation pattern signal.

16. The magnetic disk drive according to claim 12, wherein the magnetic disk drive writes the seamed pattern in the magnetic disk by the use of a self servo write system.

17. The magnetic disk drive according to claim 12, wherein the variation pattern generation section reproduces a seamless pattern of the provisional servo data to generate the variation pattern signal.

18. The magnetic disk drive according to claim 12, wherein the variation pattern generation section reproduces a gain adjustment pattern of the provisional servo data to generate the variation pattern signal.

19. A magnetic disk drive including a write head, a read head, and a magnetic disk, the magnetic disk drive comprising:
a user data transfer section that transfers a recording signal generated from user data, said user data being transmitted from a host computer;
a variation pattern recording section that records a variation pattern signal of flying height in a circumferential direction of the magnetic disk, said variation pattern signal being generated from a reproduction signal of a seamless pattern written in the magnetic disk;
a recording current control section that generates a recording current control signal on the basis of the variation pattern signal; and
a recording current generating section that converts a recording signal received from the user data transfer section into a recording current to be supplied to the write head under control according to the recording current control signal received from the recording current control section.

20. The magnetic disk drive according to claim 19, wherein a plurality of zones are set in a radial direction of the magnetic disk, and the variation pattern recording section records the variation pattern signal that is generated in each of the zones.
